(19) United States
(12) Patent Application Publication
(10) Pub. No.: US 2002/0051515 A1
(43) Pub. Date: May 2, 2002

(54) Method of and system for detecting prospective abnormal shadow

(75) Inventors: Shigeru Saotome, Kaisei-machi (JP); Kazuo Shimura, Kaisei-machi (JP); Takeshi Ohkubo, Kaisei-machi (JP); Hideya Takeo, Kaisei-machi (JP); Takashi Imamura, Kanagawa-ken (JP)

Correspondence Address: SUGHRUE, MION, ZINN, MACPEAK & SEAS, PLLC, 2100 Pennsylvania Avenue, N.W., Washington, DC, 20037-3202, US

(73) Assignee: FUJI PHOTO FILM CO., LTD.

(21) Appl. No.: 09/987,402

(22) Filed: Nov. 14, 2001

Related U.S. Application Data
(63) Continuation-in-part of application No. 09/873,417, filed on Jun. 5, 2001.

(30) Foreign Application Priority Data
Jun. 6, 2000 (JP) 169255/2000
Oct. 18, 2000 (JP) 317340/2000
Jul. 12, 2001 (JP) 211602/2001

(51) Int. Cl. H05G 1/10

(52) U.S. Cl. 378/95; 378/37

(57) ABSTRACT

In a method of detecting a prospective abnormal shadow in an image at a predetermined detecting level, the detecting level is changed according to prior information on the object.

This application is a continuation-in-part application of application Ser. No. 09/873,417 filed Jun. 5, 2001 now abandoned.

### BACKGROUND OF THE INVENTION

1. Field of the Invention

This invention relates to a method of and a system for detecting a prospective abnormal shadow in a radiation image.

2. Description of the Related Art

Conventionally, disease or injury of a patient has been sometimes diagnosed by reading an X-ray film on which a radiation image of the patient is recorded. Recently, there has been developed a system in which a radiation image of a patient is once stored on a stimulable phosphor sheet (or a radiation image conversion panel) by exposing the stimulable phosphor sheet to radiation through the object (patient) to have the stimulable phosphor sheet store radiation energy, and stimulated emission which is emitted from each part of the stimulable phosphor sheet upon exposure to stimulating light in proportion to the radiation energy stored thereon is digitally read, thereby obtaining a digital image signal representing the radiation image stored on the stimulable phosphor sheet, and the digital image signal is reproduced as a visible image on a recording medium such as a photographic film or on an image display system such as those using a CRT. (A radiation image recording and read-out apparatus: computed radiography, see, for instance, Japanese Unexamined Patent Publication Nos. 55(1975)-12429, 56(1976)-11395 and 56(1976)-11397)

In accordance with such a radiation image recording and read-out apparatus, by carrying out image processing on the digital image signal in various ways, the tone properties and the frequency properties of the output visible image can be improved so that the visible image becomes more suitable for reading and diagnose through the visible image can be made more correctly.

Further, there has been developed a system in which the digital image signal is analyzed by a computer to automatically detect an abnormal shadow representing a growth, a micro calcification or the like, whereby a certain detecting level can be ensured irrespective of the skillfulness of the reader. (Prospective abnormal shadow detecting system: see, for instance, Japanese Unexamined Patent Publication Nos. 8(1996)-294479 and 8(1996)-287230)

In this system, the degree of convergence of density (signal value) gradient vectors is evaluated in a digital image signal of a breast (a mammogram) mainly obtained by breast cancer examination, thereby automatically detecting a prospective growth shadow in the radiation image, or a prospective micro calcification shadow is automatically detected by carrying out morphology operation (e.g., dilation processing, erosion processing, opening processing, and closing processing). The prospective abnormal shadow thus detected is marked with a ROI frame or the like on a visible image reproduced on a display such as of a CRT or a liquid crystal display or on a print. Then the display or the print is used for diagnosis.

Such a prospective abnormal shadow detecting system can detect prospective abnormal shadows at a certain detecting level irrespective of the skillfulness of the reader and is very effective in suppressing overlooking prospective abnormal shadows. However, since the system detects the prospective abnormal shadow solely on the basis of the image, information obtained from a source other than the image, e.g., prior information obtained from meeting with the patient, examination by touch, or the past history of the patient, cannot be reflected on the result of detection. For example, even if the doctor believes that there is a higher probability that the radiation image of the patient includes an abnormal shadow on the basis of the prior information, the system detects no abnormal shadow if there is no shadow equal to or higher than a preset detecting level. In such a case, the doctor (or the reader) interprets the result of prospective abnormal shadow detection and reading of the radiation image taking into account the prior information and when he still suspects that there should be a prospective abnormal shadow, the prospective abnormal shadow detection is carried out again with the detecting level changed and the doctor determines whether there is a prospective abnormal shadow on the basis of the result of the second prospective abnormal shadow detection.

However, when it is suspected on the basis of prior information that there is a prospective abnormal shadow in the radiation image, that prospective abnormal shadow detection is once carried out with the detecting level set to a normal level and the prospective abnormal shadow detection is carried out again with the detecting level lowered when no prospective abnormal shadow can be detected by the first prospective abnormal shadow detection is waste of time. Further, there is a fear that the second prospective abnormal shadow detection is failed and a prospective abnormal shadow is overlooked.

Further, when taking a radiation image, photographing conditions (e.g., the tube voltage of the radiation source, the irradiation dose (irradiating time), whether a grid is used, and the like) are sometimes set according to the object. The difference in the photographing conditions can vary the sensitivity of the radiation image to detection of the prospective abnormal shadow, which can result in difference in the result of detection of the prospective abnormal shadow.

### SUMMARY OF THE INVENTION

In view of the foregoing observations and description, the primary object of the present invention is to provide a method of and a system for detecting a prospective abnormal shadow in a radiation image in which prospective abnormal shadow detection is carried out taking into account conditions specific to the radiation image such as prior information on the object, the photographing conditions and the like, whereby reliability in detection of a prospective abnormal shadow is improved.

Another object of the present invention is to provide an apparatus for detecting a prospective abnormal shadow in a radiation image which can detect a prospective abnormal shadow less affected by the photographing conditions of the radiation image.

The method of and the system for detecting a prospective abnormal shadow in a radiation image in accordance with the present invention is characterized in that the prospective abnormal shadow detecting level is changed according to prior information on the object of the radiation image and or the photographing conditions of the radiation image.

That is, in accordance with a first aspect of the present invention, there is provided a method of detecting a prospective abnormal shadow in an image at a predetermined detecting level, wherein the improvement comprises that the detecting level is changed according to prior information on the object.

That the detecting level is changed according to prior information on the object means that the condition on the basis of which a part of the image is determined to be a prospective abnormal shadow is relaxed so that the detection probability of a prospective abnormal shadow is increased at least when the prior information on the object is such as to indicate a higher probability of existence of an abnormal shadow.

As the prior information, for instance, such as obtained from meeting with the patient, examination by touch, or the past history of the patient may be employed. The prior information obtained from meeting with the patient includes, for instance, age, gender, weight, habit (eating habits, sleeping hours and the like), taste (drinking habit, smoking habit and the like), work (whether the patient handles radiation, asbestos, or other chemicals), the symptoms of which the patient is conscious (e.g., pain), the past history of the patient's family and the like. For example, since there is a tendency that cancer (abnormal shadow) breaks out at a higher rate in people of higher age, the detecting level is changed so that the detection probability of a prospective abnormal shadow is increased. Further, there is a tendency that the contrast of abnormal shadow is weakened as the weight of the patient increases. Accordingly, the detecting level is changed so that the detection probability of a prospective abnormal shadow is increased as the weight of the patient increases. In the case of cancer, which largely differs in the rate of outbreak according to gender, the detecting level is changed according to the gender of the patient. Further, when the eating habit of the patient greatly leans toward outbreak of tumor, when the patient drinks a lot, when the patient smokes, when the patient handles radiation, asbestos, or other chemicals in his or her work, or when the patient is conscious of his or her symptoms, the detecting level is changed so that the detection probability of a prospective abnormal shadow is increased.

When the patient has a patient of cancer or the like in his or her family, the patient may be immunologically considered to be apt to suffer from the cancer and accordingly, the detecting level is to be changed so that the detection probability of a prospective abnormal shadow is increased. When the patient was treated for tumor or the like, the disease is apt to return. Accordingly, the detecting level is to be changed so that the detection probability of a prospective abnormal shadow is increased. When an induration has been found through examination by touch, the detecting level is to be changed so that the detection probability of a prospective abnormal shadow is increased.

To the contrast when the prior information on the object is such as to indicate a lower probability of existence of an abnormal shadow, the detecting level may be changed so that the detection probability of a prospective abnormal shadow is decreased.

When the part where there is a high probability of existence of an abnormal shadow can be specified to some extent through, for instance, prior information obtained by examination by touch, the detecting level may be changed only for a specified part of the image or may be changed part by part.

Though being more useful when applied to a mammogram which is a radiation image of the breast for examination of breast cancer, the present invention can be applied to various radiation images, for instance, to a radiation image of the chest.

It is preferred that the prospective abnormal shadow be basically detected by the method employed, for instance, in the aforesaid prospective abnormal shadow detecting system disclosed in Japanese Unexamined Patent Publication No. 8(1996)-294479). In the prospective abnormal shadow detecting system, a prospective growth shadow in a radiation image is automatically detected by an iris filter processing in which the degree of convergence of density (signal value) gradient vectors is evaluated in a digital image signal representing the radiation image, or a prospective micro calcification shadow is automatically detected by carrying out morphology operation (e.g., dilation processing, erosion processing, opening processing, and closing processing). In this system, the detecting level can be changed by changing a threshold value employed in evaluation of the degree of convergence of density gradient vectors (e.g., a threshold value T1 with which the output value I of the iris filter processing is compared as will be described later), or by changing the values of structural elements in the morphology operation and a threshold value employed in evaluation of the degree of malignancy after the morphology operation (e.g., threshold values T2, T3 and the like in formula (17) to be described later). Needless to say, the prospective abnormal shadow may be detected by other various methods.

As reported by Obata, et. al, of Tokyo University of Agriculture and Technology in “Growth Shadow Detection in a DR image (Iris Filter)” (Journal of Academy of Electronics/Information/Communication D-II, vol. J75-D-II No. 3, pp663 to 670, March 1992), the iris filter processing has been studied as a method especially useful to detect a prospective growth shadow specific to breast cancer. However, the iris filter processing can be employed to detect not only the growth shadow in a mammogram but also other abnormal shadows in any radiation image so long as gradients of image signal components of the image signal representing the radiation image are converged at the abnormal shadows.

Detection of a prospective growth shadow by the iris filter will be briefly described, hereinbelow.

For example, it has been known that in a radiation image recorded on an X-ray film (an image represented by a high density, high level image signal), a growth shadow is generally lower in density than surroundings, and the density distribution in the growth shadow is such that the density is higher at the periphery thereof which substantially circular and lowers toward the center. That is, when a radiation image includes a growth shadow, a local density gradient toward the center of the growth is observed.

The iris filter calculates the gradient of image signals (e.g., densities) as gradient vectors and outputs the degree of convergence of the gradient vectors, and in the iris filter processing, a prospective growth shadow is detected on the basis of the degree of convergence of the gradient vectors.

In a mammogram P shown in FIG. 5A, a gradient vector at a given pixel in a growth shadow PJ is directed toward the center of the growth shadow PJ as shown in FIG. 5B. Whereas, gradient vectors are not directed toward a particular point in an elongated shadow PK such as a shadow of a blood vessel or a mammary gland as shown in FIG. 5C. Accordingly, a prospective growth shadow can be found by evaluating orientations gradient vectors part by part and extracting an area where gradient vectors are converged on a particular point.

In a shadow PL formed by a pair of elongated shadows intersecting each other as shown in FIG. 5D, gradient vectors are apt to be directed toward a particular point and such a shadow can be mistaken for a prospective abnormal shadow. Specified steps for carrying out the algorithm will be described hereinbelow.

(Step 1): Calculation of the Gradient Vectors

Orientation of the gradient vector of image data for each of the pixels j of the image is calculated according to the following formula (1).

$$θ = {tan}^{- 1} ( {f}_{3} + {f}_{4} + {f}_{5} + {f}_{6} + {f}_{7} ) - \frac{( {f}_{11} + {f}_{12} + {f}_{13} + {f}_{14} + {f}_{15} )}{( {f}_{1} + {f}_{2} + {f}_{3} + {f}_{15} + {f}_{16} ) - ( {f}_{7} + {f}_{8} + {f}_{9} + {f}_{10} + {f}_{11} )} \qquad ( 1 )$$

wherein f₁ to f₁₆ are, as shown in FIG. 6, values (image data) of pixels on the outer periphery of a 5×5 pixel mask about a given pixel j (pixel of current interest).

(Step 2): Calculation of the Degree of Convergence of the Gradient Vectors

Then, the degree of convergence C of the gradient vectors onto each of the pixels j of the image is calculated according to the following formula (2).

$$C = ( 1 / N ) {\sum }_{j = 1}^{N} cos {θ}_{j} \qquad ( 2 )$$

wherein N represents the number of pixels in a circle with its center at a pixel of current interest and with a radius of R and θⱼ represents the angle between the straight line connecting the pixel of current interest and each of the pixels j in the circle and the gradient vector for the pixel j as calculated according to the aforesaid formula (1) as shown in FIG. 7. Accordingly, the degree of convergence C as calculated according the aforesaid formula (2) becomes high when many of the orientations of the gradient vectors for the pixels j are directed toward the pixel of current interest.

Since the gradient vectors for pixels near a growth shadow are all directed toward the center of the growth shadow irrespective of the contrast of the growth shadow, a pixel of current interest which is high in the degree of convergence C may be considered to be a pixel at the center of the growth shadow. On the other hand, in a line pattern shadow such as of a blood vessel, gradient vectors are apt to be oriented in one direction and accordingly, the degree of convergence C does not become high. Accordingly, it is possible to detect a growth shadow by determining whether the degree of convergence C for each of the pixels in the image is higher than a predetermined threshold value. That is, this filter is less susceptible to blood vessels or mammary glands as compared with a normal differential filter and can effectively detect growth shadows.

In actual processing, it is preferred that the size and shape of the filter be changed to conform to the size and shape of the growth so that growth can be detected without affected by the size and shape of the growth. FIG. 8 shows an example of such a filter. In the filter shown in FIG. 8, the degree of convergence C is evaluated on the basis of only pixels on radial lines extending from the pixel of current interest in M directions at regular intervals of 2π/M (in the example shown in FIG. 8, in 32 directions at regular intervals of 11.25°.

The coordinates ([x], [y]) of a pixel which is in an i-th direction (on an i-th radial line) and an n-th pixel as numbered from the pixel of current interest are given by the following formulae (3) and (4) wherein (k, l) are the coordinates of the pixel of current interest, and [x] and [y] are maximum integers which are not larger than x and y, respectively.

x=k+n cos {2π(i−1)/M} (3)

x=l+n cos {2π(i−1)/M} (4)

The value of outputs of the pixels from the pixel of current interest to the pixel at which the degree of convergence C is maximized on each of the 32 directions is taken as the degree of convergence Cᵢₘₐₓ in the direction, and the degrees of convergence Cᵢₘₐₓ in all the directions are averaged. The average of the degrees of convergence Cᵢₘₐₓ in all the directions thus obtained is taken as the degree of convergence C of the gradient vectors for the pixel of current interest.

Specifically, the degrees of convergence Cᵢ₍ₙ₎ are calculated for pixels in the range of from a pixel of current interest to a pixel which is in an i-th direction (on an i-th radial line) and an n-th pixel as numbered from the pixel of current interest is calculated according to the following formula (5).

$${C}_{i ( n )} = {\sum }_{i - 1}^{n} \{ ( cos {θ}_{il} ) / n \} , {R}_{min} \leq n \leq {R}_{max} \qquad ( 5 )$$

That is, formula (5) is for calculating the degrees of convergence Cᵢ₍ₙ₎ for the pixels in the range of from the pixel of current interest to a pixel which is between the Rₘᵢₙ-th pixel and the Rₘₐₓ-th pixel as numbered from the pixel of current interest on each radial line, the values of Rₘᵢₙ and Rₘₐₓ respectively corresponding to a minimum radius and a maximum radius of a growth shadow to be extracted.

Then the degrees of convergence C of the gradient vectors are calculated according to the following formulae (6) and (7).

$$\begin{matrix}\begin{matrix}{C}_{i max} = max Ci ( n ) \\ {R}_{min} \leq n \leq {R}_{max}\end{matrix} & ( 6 ) \\ C = ( 1 / 32 ) {\sum }_{i = 1}^{32} {C}_{i max} & ( 7 )\end{matrix}$$

Since the Cᵢₘₐₓ obtained from formula (6) is the maximum value of the degrees of convergence Cᵢ₍ₙ₎ in each direction obtained according to formula (5), the area between the pixel of current interest and the pixel at which the degree of convergence Cᵢ₍ₙ₎ is maximized is a prospective growth shadow area in the direction.

By obtaining prospective growth shadow areas in all the directions according to formula (6) and connecting the prospective growth shadow areas in adjacent directions, the outer shape of the overall prospective growth shadow area can be determined.

In formula (7), the maximum values Cᵢₘₐₓ of the degrees of convergence Cᵢ₍ₙ₎ for the respective directions are averaged. The average of the maximum values Cᵢₘₐₓ of the degrees of convergence Cᵢ₍ₙ₎ is the output I of the iris filter processing. The output I of the iris filter processing is compared with a threshold value T1, and it is determined that the area having its center at the pixel of current interest is a prospective growth shadow (a prospective abnormal shadow) when the output I is larger than the threshold value T1, and that the area is not a prospective growth shadow when the output I is not larger than the threshold value T1.

Since the area over which the degrees of convergence C of the gradient vectors varies in its size and shape according to the gradient vector distribution in a similar manner to that in which the human iris is enlarged and contracted according to the ambient brightness, the method of detecting a prospective growth shadow using the degree of convergence of gradient vectors is called “iris filter processing”.

The degree of convergence Cᵢ₍ₙ₎ may be calculated according to the following formula (5′) in place of the aforesaid formula (5).

$${C}_{i ( n )} = \frac{1}{n - {R}_{min + 1}} {\sum }_{i = {R}_{min}}^{n} cos {θ}_{il} , {R}_{min} \leq n \leq {R}_{max} \qquad ( {5}^{′} )$$

That is, formula (5′) is for calculating the degrees of convergence Cᵢ₍ₙ₎ for the pixels in the range of from the Rₘᵢₙ-th pixel to a pixel which is between the Rₘᵢₙ-th pixel and the Rₘₐₓ-th pixel as numbered from the pixel of current interest on each radial line, the values of Rₘᵢₙ and Rₘₐₓ respectively corresponding to a minimum radius and a maximum radius of a growth shadow to be extracted.

According to the aforesaid steps, only growth shadows of a desired size can be effectively extracted.

A malignant growth shadow generally has the following features in shape.

1) Having an irregular edge,

2) Substantially circular in shape, and

3) Uneven density distribution inside the shadow.

In order to improve accuracy of diagnosis, a shape-based decision may be further carried out on the image signal representing the prospective abnormal shadow obtained through the comparison of the output I of the iris filter with the threshold value T1, taking into account these features of a malignant growth shadow. Spreadness, elongation, roughness of the edge, circularity, uneven density distribution inside the shadow (entropy) and the like can be employed as characteristic values here. These characteristic values are compared with second threshold values T2 and it is determined whether the prospective abnormal shadow obtained through the comparison of the output I of the iris filter with the threshold value T1 is to be taken as a final prospective abnormal shadow on the basis of the result of the comparison. Though an additional processing such as the shape-based decision to be carried out in addition to the iris filter processing is strictly not the iris filter processing in itself, the iris filter processing with such an additional processing will be sometimes referred to as “processing based on the iris filter processing”, hereinbelow.

The morphology operation is a method of automatically detecting a prospective micro calcification shadow which is a specific form of breast cancer by the use of a multi-scale λ and a structural element (mask) B. The morphology operation is characterized in that it is effective to extract a calcification shadow itself, it is less susceptible to complicated background information and the extracted calcification shadow is less apt to be strained. That is, in accordance with the morphology operation, a calcification shadow can be detected with geometric information on the calcification shadow such as the size, shape and density distribution well preserved. The morphology operation will be briefly described hereinbelow.

(The Fundamentals of Morphology Operation)

Though the morphology operation is generally developed as a set theory in a N-dimensional space, it will be discussed here on the basis of a two-dimensional tone image for the purpose of simplicity of understanding.

It is assumed that a tone image is a space in which a point (x, y) has a height corresponding to a value of density f(x, y). Further it is assumed that the value of density f(x, y) is represented by a high brightness, high level signal in which as the value of density decreases (the value of brightness increases when displayed on a CRT), the level of the signal becomes higher.

For the purpose of simplicity, a linear function f(x) corresponding to a cross-section of the image is first discussed. It is assumed that a structural element g employed in the morphology operation is a function which is represented by the following formula (8), is symmetrical about the origin, and is 0 in value in a domain represented by the following formula (9).

g^{s}(x)=g(−x) (8)

G={−m, −m+1, . . . , −1, 0, 1, . . . , m−1, m} (9)

At this time, the fundamental form of the morphology operation is very simple as shown in the following formulae (10) to (13).

dilation: [f G^{s}](i)=max {f(i−m), . . . , f(i), . . . , f(i+m)} (10)

erosion: [f G^{s}](i)=min {f(i−m), . . . , f(i), . . . , f(i+m)} (11)

opening: fₛ=(f g^{s})g (12)

closing: f^{s}=(f g^{s})g (13)

That is, the dilation processing is processing for searching a maximum value in the area whose width is ±m (a value determined according to the structural element B) and whose center is at the pixel of current interest, see FIG. 9A, and the erosion processing is processing for searching a minimum value in the same area, see FIG. 9B. The opening processing corresponds to searching a maximum value after searching a minimum value, and the closing processing corresponds to searching a minimum value after searching a maximum value. In other words, the opening processing smoothens the density curve f(x) from the low brightness side by removing protrusions in density (the portions which are higher in brightness than the surroundings) which are narrower than the mask size 2 m (see FIG. 9C), whereas the closing processing smoothens the density curve f(x) from the high brightness side by removing recesses in density (the portions which are lower in brightness than the surroundings) which are narrower than the mask size 2 m (see FIG. 9D).

In the case of a high density, high level signal in which as the value of density increases, the level of the signal becomes higher, the value of image signal for the value of density f(x) is reverse to that of a high brightness, high level signal. Accordingly, the dilation processing for a high density, high level signal corresponds to the erosion processing for a high brightness, high level signal. Similarly, the erosion processing for a high density, high level signal corresponds to the dilation processing for a high brightness, high level signal, the opening processing for a high density, high level signal corresponds to the closing processing for a high brightness, high level signal, and the closing processing for a high density, high level signal corresponds to the opening processing for a high brightness, high level signal. Description will be made only on the high brightness, high level signal here.

(Application to Detection of a Calcification Shadow)

As a method of detecting a calcification shadow, a subtraction method in which a smoothened image is subtracted from an original image is conceivable. Since it is difficult to distinguish a calcification shadow from an elongated non-calcification shadow (e.g., of a mammary gland, a blood vessel, and a mammary gland supporting tissue) by a simple smoothening method, Obata, et al, have proposed morphology operation processing based on opening operation using multiple structural elements as represented by the following formula (14). See “Extraction of Micro Calcification Shadow by a Morphology Filter using multiple Structural Elements” (Journal of Academy of Electronics/Information/Communication D-II, vol. J75-D-II No. 7, pp1170 to 1176, Jul. 1992) and “Fundamentals of Morphology and its Application to Mammogram” (MEDICAL IMAGING TECHNOLOGY, Vol. 12, No. 1 January 1994)

$$\begin{matrix}P = f - {max}_{i ∈ ( 1 , … , M )} \{ ( f ⊖ Bi ) ⊕ Bi \} \\ = f - {max}_{i ∈ ( 1 , … , M )} \{ {f}_{Bi} \}\end{matrix} \qquad ( 14 )$$

wherein Bi (i stands for 1, 2, 3 and 4) are four linear structural elements B shown in FIG. 10. When the structural elements B are larger than the calcification shadow to be detected, calcification shadows which are signal protrusions narrower than the structural elements B (a part of image the image signal of which fluctuates in a range spatially narrower than the structural elements B) are removed by opening processing. On the other hand, an elongated non-calcification shadow is left there as it is after the opening processing (calculation of the second term in formula 14) so long as it is longer than the structural elements B and its inclination (the direction in which the shadow extends) conforms to any one of the four structural elements Bᵢ. Accordingly, by subtracting the smoothened image (the image removed with the calcification shadow) obtained by the opening processing from the original image f, an image containing therein only a small prospective calcification shadow is obtained. This the concept of formula (14).

In the case of a high density, high level signal, closing processing is applied according to the following formula (15) in place of opening processing.

$$\begin{matrix}P = f - {min}_{i ∈ ( 1 , … , M )} \{ ( f ⊕ Bi ) ⊖ Bi \} \\ = f - {min}_{i ∈ ( 1 , … , M )} \{ {f}_{Bi} \}\end{matrix} \qquad ( 15 )$$

However, a non-calcification shadow equivalent to a calcification shadow in size can remain. In such a case, non-calcification shadows contained in P of formula (14) are further removed by the use of differential information based on a morphology operation according to the following formula (16).

M_{grad}=(1/2)×{f λB−f λB} (16)

As the value of M_{grad} increases, the probability that the shadow is of a calcification increases. Accordingly, a prospective calcification shadow Cₛ can be obtained according to the following formula (17).

If P(i, j)≧T2, and M_{grad}(i, j)≧T3

Then, Cₛ(i, j)=P else Cₛ(i, j)=0 (17)

T2 and T3 are empirically determined threshold values.

Since a non-calcification shadow different from a calcification shadow in size can be removed only by comparison of P obtained according to formula (14) and the threshold value T2, only the condition of the first term of formula (17), P(i, j)≧T2 has to be satisfied in the case where there is no possibility that a non-calcification shadow equivalent to a calcification shadow in size remains.

Also in the morphology operation, an additional processing such as the shape-based decision described above in conjunction with the iris filter processing may be carried out in addition to the morphology operation. Also in this case, the morphology operation with such an additional processing will be sometimes referred to as “processing based on the morphology operation”, hereinbelow.

In accordance with a second aspect of the present invention, there is provided a method of detecting a prospective abnormal shadow in an image of an object at a predetermined detecting level, wherein the improvement comprises that the detecting level is changed according to photographing conditions under which the image of the object is taken.

The detecting level may be changed in the same manner as in the method of the first aspect of the present invention.

As is well known, the quality of image varies according to the photographing conditions. For example, in a radiation image obtained by a smaller irradiation dose, a structure which is high in spatial frequency (e.g., a micro calcification shadow) is less apt to be detected than in a radiation image obtained by a larger irradiation dose. Accordingly, the prospective abnormal shadow detecting level varies according to the photographing conditions. That the detecting level is changed according the photographing conditions means that the condition on the basis of which a part of the image is determined to be a prospective abnormal shadow is relaxed so that the detection probability of a prospective abnormal shadow is increased when the photographing conditions are such as to lower the probability of existence of an abnormal shadow. Similarly, the detecting level may be changed so that the detection probability of a prospective abnormal shadow is decreased when the photographing conditions are such as to increase the probability of existence of an abnormal shadow.

The photographing conditions include the tube voltage and the tube current of the radiation source, the irradiating time, the product of the tube current and the irradiating time (the mAs value), the degree of compression of the object when the object is photographed under pressure (especially when the object is the breast, the pressure on the breast or the thickness to which the breast is compressed), whether a grid for preventing scattering is used, the kind of the grid used, the magnifying power and the like.

In accordance with a third aspect of the present invention, there is provided a system for carrying out the method of detecting a prospective abnormal shadow in a radiation image in accordance with the first aspect of the present invention. That is, in accordance with the third aspect of the present invention, there is provided a system for detecting a prospective abnormal shadow in an image of an object comprising a prospective abnormal shadow detecting means which detects a prospective abnormal shadow at a predetermined detecting level, wherein the improvement comprises that

there are provided a prior information input means through which prior information on the object is input, and a detecting level changing means which changes the detecting level according to the prior information on the object input through the prior information input means, and

that the prospective abnormal shadow detecting means detects a prospective abnormal shadow according to the detecting level changed by the detecting level changing means.

In accordance with a fourth aspect of the present invention, there is provided a system for carrying out the method of detecting a prospective abnormal shadow in a radiation image in accordance with the second aspect of the present invention. That is, in accordance with the fourth aspect of the present invention, there is provided a system for detecting a prospective abnormal shadow in an image of an object comprising a prospective abnormal shadow detecting means which detects a prospective abnormal shadow at a predetermined detecting level, wherein the improvement comprises that

there are provided a photographing condition input means through which photographing conditions under which the image of the object is taken is input, and a detecting level changing means which changes the detecting level according to the photographing conditions input through the photographing condition input means, and

that the prospective abnormal shadow detecting means detects a prospective abnormal shadow according to the detecting level changed by the detecting level changing means.

It is preferred that the detecting level changing means changes the detecting level part by part. In this case, it is natural for the prospective abnormal shadow detecting means to detect a prospective abnormal shadow according to the detecting level changed by the detecting level changing means part by part.

In accordance with a fifth aspect of the present invention, there is provided an apparatus for detecting a prospective abnormal shadow in a radiation image of an object comprising

a photographing condition input means through which photographing conditions under which the radiation image of the object is taken is input, and

a prospective abnormal shadow detecting means which detects a prospective abnormal shadow on the basis of the photographing conditions input through the photographing condition input means and radiation image data representing the radiation image of the object.

The photographing conditions are conditions which can affect the quality of the radiation image and the like and include the kind of the grid employed in photographing, the tube voltage of the radiation source, the kind of the filter for controlling the quality of radiation to which the object is exposed, the irradiating time, the pressure on the breast and/or the thickness to which the breast is compressed (when the object is the breast and the breast is photographed under pressure), and the like.

The kind of the grid employed in photographing means the kind of the grid mounted on the X-ray apparatus, and may be divided, for instance, by material of the grid or the number of grid lines. That is, the kind of the grid may be divided by a feature which will affect the contrast of recorded images.

The prospective abnormal shadow detecting means may comprise a detection processing condition determining section which determines the detection processing conditions on the basis of the photographing conditions, and a prospective abnormal shadow detecting section which detects a prospective abnormal shadow through a predetermined detection processing on the basis of the radiation image data and the detection processing conditions determined by the detection processing condition determining section.

The detection processing conditions are conditions which can affect the level of abnormal shadow which can be detected by the predetermined detection processing and include, for instance, a threshold value and filtering properties of a shape-dependent filter employed in the detection processing.

The shape-dependent filter is a matched filter formed according to geometric information on the micro calcification shadow such as the size and density distribution of the micro calcification shadow. A plurality of shape-dependent filters different in properties are generally prepared in advance according to properties of micro calcification shadows expected to appear in the radiation image. The shape-dependent filter may be formed each time the properties of the micro calcification shadow to be detected change.

The predetermined detection processing may be any processing so long as the level of abnormal shadow which can be detected by the detection processing can be changed by changing the detection processing conditions and may be, for instance, processing for detecting a micro calcification shadow by morphology operation.

The prospective abnormal shadow detecting means may comprise an image conversion section which carries out predetermined image conversion processing on the radiation image data on the basis of the photographing conditions, and a prospective abnormal shadow detecting section which detects a prospective abnormal shadow through a predetermined detection processing on the basis of the converted radiation image data.

The image conversion processing may be, for instance, frequency enhancement processing.

The apparatus in accordance with the fifth aspect of the present invention is especially useful when the radiation image is a breast radiation image or when the abnormal shadow is a micro calcification shadow.

Thus, in accordance with the present invention, the processing for detecting a prospective abnormal shadow is effected taking into account conditions which differ according to the patients and/or the radiation image, e.g., the prior information on the patient, the photographing conditions of the radiation image and the like. Accordingly, reliability of detection of a prospective abnormal shadow can be improved. Further, the result of detection is not affected by the skillfulness of the reader, whether the reader knows the prior information on the patient, and the photographing conditions.

### BRIEF DESCRIPTION OF THE DRAWINGS

FIG. 1 is a schematic block diagram showing a prospective abnormal shadow detecting system in accordance with a first embodiment of the present invention,

FIG. 2 is a block diagram for illustrating a computer-aided radiation image diagnosis apparatus employing the prospective abnormal shadow detecting system shown in FIG. 1,

FIG. 3 is a view showing an example of a mammogram represented by the image signal input into the computer-aided radiation image diagnosis apparatus shown in FIG. 3,

FIG. 4 is a schematic block diagram showing a prospective abnormal shadow detecting system in accordance with a second embodiment of the present invention,

FIGS. 5A to 5D are views for illustrating the degree of convergence of density gradient vectors in a mammogram,

FIG. 6 is a view showing mask for calculating gradient vectors in the iris filter processing,

FIG. 7 is a view for illustrating the degree of convergence of gradient vectors for the pixel of current interest,

FIG. 8 is a view for illustrating an iris filter whose size and shape are changed to conform to the size and shape of the growth,

FIGS. 9A to 9D are views for illustrating the morphology operation,

FIG. 10 is a view for illustrating a concept of a structural elements employed in the morphology operation,

FIG. 11 is a block diagram showing a prospective abnormal shadow detecting apparatus in accordance with a third embodiment of the present invention,

FIG. 12A is a view showing a mammogram including a typical micro calcification shadow,

FIG. 12B is a view showing a mammogram including an unsharp micro calcification shadow,

FIGS. 13A and 13B are views illustrating calcification enhancement filters,

FIG. 14A is a view showing signal values of an original image,

FIG. 14B is a view showing signal values of a micro structure image,

FIG. 14C is a view showing signal values of a calcification-enhanced image, and

FIG. 15 is a block diagram showing a prospective abnormal shadow detecting apparatus in accordance with a fourth embodiment of the present invention.

### DESCRIPTION OF THE PREFERRED EMBODIMENTS

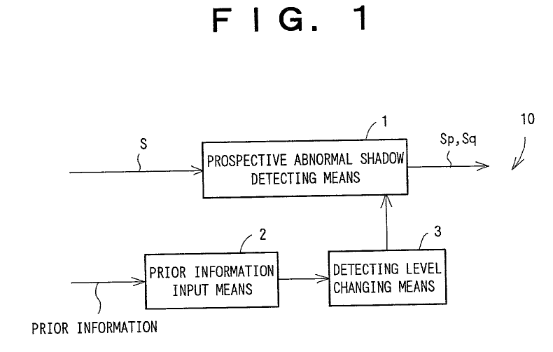

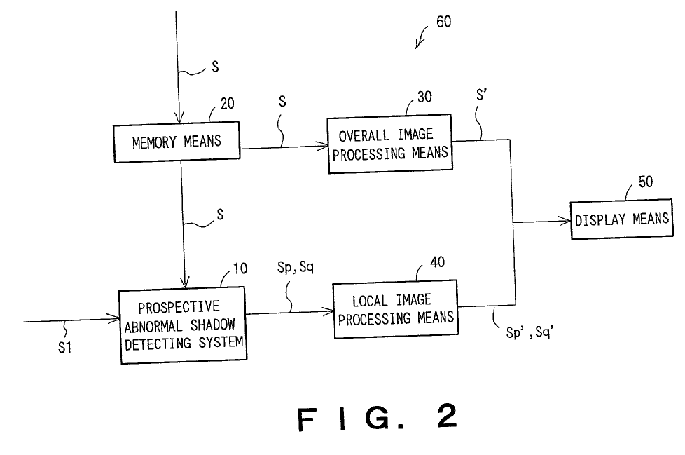

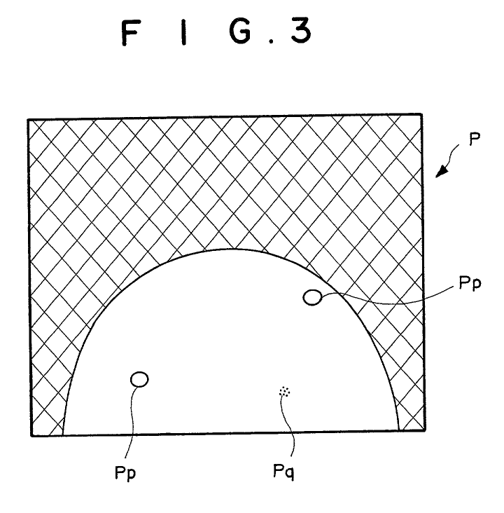

In FIG. 2, a computer-aided radiation image diagnosis apparatus 60 is provided with a prospective abnormal shadow detecting system 10 in accordance with an embodiment of the present invention shown in FIG. 1. The computer-aided radiation image diagnosis apparatus 60 comprises a memory means 20 which stores an input image signal S (will be referred to as “the overall image signal”, hereinbelow), an overall image processing means 30 which reads out the overall image signal S from the memory means 20 and carries out image processing such as gradation processing, frequency enhancement processing and the like on the overall image signal S, the prospective abnormal shadow detecting system 10 (shown in FIG. 1) which reads out the overall image signal S from the memory means 20 and detects local image signals Sp and Sq representing prospective abnormal shadows Pp and Pq (FIG. 3) in the overall image signal S, a local image processing means 40 which carries out on the local image signals Sp and Sq image processing for enhancing the prospective abnormal shadows Pp and Pq represented by the local image signals Sp and Sq, and a display means 50 which displays as a visible image an overall image P represented by the processed overall image signal S′ in combination with the prospective abnormal shadows Pp′ and Pq′ represented by the processed local image signals Sp′ and Sq′.

The overall image signal S input into the computer-aided radiation image diagnosis apparatus 60 is, for instance, an image signal (a high density, high level image signal) obtained by exposing a stimulable phosphor sheet, on which a breast radiation image of a patient (a mammogram P) such as shown in FIG. 3 has been recorded, to stimulating light, photoelectrically detecting stimulated emission emitted from the stimulable phosphor sheet upon exposure to the stimulating light, and digitizing the analog image signal thus obtained.

In this particular embodiment, the overall image P represented by the processed overall image signal S′ is displayed by the display means 50 with the parts corresponding to the prospective abnormal shadows Pp and Pq replaced by the prospective abnormal shadows Pp′ and Pq′ represented by the processed local image signal Sp′ and Sq′. However, the overall image P and the prospective abnormal shadows Pp′ and Pq′ may be displayed in other various manners. For example, the overall image P as represented by the processed overall image signal S′ may be displayed at a part of one frame with the prospective abnormal shadows Pp′ and Pq′ as represented by the processed local image signal Sp′ and Sq′ displayed at other parts of the frame.

As shown in detail in FIG. 1, the prospective abnormal shadow detecting system 10 of this embodiment comprises a prospective abnormal shadow detecting means 1 which carries out predetermined operation processing on the overall image signal S and compares the output value of the operation processing with threshold values T (i.e., threshold values T1, T2 and T3 to be described later), thereby detecting prospective abnormal shadows Pp and Pq in the radiation image P represented by the image signal S, a prior information input means 2 through which prior information S1 on the object is input, and a detecting level changing means 3 which changes the prospective abnormal shadow detecting level at which the prospective abnormal shadow detecting means 1 detects a prospective abnormal shadow.

In this particular embodiment, mammograms (the overall image) P obtained by breast cancer examination are read by the computer-aided radiation image diagnosis apparatus 60 shown in FIG. 2, and in FIG. 3, Pp represents a growth shadow of breast cancer and Pq represents a micro calcification shadow of breast cancer.

The prospective abnormal shadow detecting means 1 detects a prospective growth shadow Pp through the aforesaid iris filter processing and subsequent comparison of the output value I of the iris filter processing with the threshold value T1 and detects a prospective micro calcification shadow Pq through the aforesaid morphology operation and subsequent processing with the threshold values T2 and T3 according to formula (17). That is, when the output value I of the iris filter processing for a given part in the overall image P is larger than the threshold value T1 (I>T1), the prospective abnormal shadow detecting means 1 determines that the part is a prospective growth shadow Pp, and otherwise (i.e., when the output value I of the iris filter processing for the part is not larger than the threshold value T1 (I≦T1), the prospective abnormal shadow detecting means 1 determines that the part is not a prospective growth shadow Pp. Further, when P(i, j) and M_{grad} for a given part obtained by the morphology operation (see the aforesaid formulae (15) and (16)) are not respectively smaller than the threshold values T2 and T3, that is, when P(i, j)≧T2 and M_{grad≧T}3, the prospective abnormal shadow detecting means 1 determines that the part is a prospective micro calcification shadow Pq. Otherwise, the prospective abnormal shadow detecting means 1 determines that the part is not a prospective micro calcification shadow Pq. Accordingly, the prospective growth shadow detecting level can be changed by changing the threshold value T1 and the prospective micro calcification shadow detecting level can be changed by changing the threshold values T2 and T3.

The prior information input through the prior information input means 2 includes information obtained from meeting with the patient and/or examination by touch, the past history of the patient and the like. For example, when the patient has one or more persons who suffered from cancer or the like in his or her relatives, the detecting level changing means 3 reduces the threshold values T1, T2 and T3 so that the detection probability of a prospective abnormal shadow is increased. When the patient was treated for tumor or the like, the disease is apt to return. Accordingly, the detecting level changing means 3 reduces the threshold values T1, T2 and T3 so that the detection probability of a prospective abnormal shadow is increased. When an induration has been found through examination by touch, the detecting level changing means 3 reduces the threshold values T1, T2 and T3 so that the detection probability of a prospective abnormal shadow is increased.

Operation of the computer-aided radiation image diagnosis apparatus 60 will be described hereinbelow.

When an overall image signal S representing a mammogram P is input into the apparatus 60, the overall image signal S is once stored in the memory means 20. Then the overall image processing means 30 reads out the overall image signal S from the memory means 20 and carries out image processing such as gradation processing, frequency enhancement processing and the like on the overall image signal S. The prospective abnormal shadow detecting system 10 also reads out the overall image signal S from the memory means 20. The overall image signal S is input into the prospective abnormal shadow detecting means 1 of the system 10.

The prior information S1 on the object is input into the prospective abnormal shadow detecting system 10 through the prior information input means 2. The prior information S1 may be input from an electronic chart for the patient.

The prior information S1 input through the prior information input means 2 is transferred to the detecting level changing means 3 and the detecting level changing means 3 changes the threshold values T1, T2 and T3 stored in the prospective abnormal shadow detecting means 1 according to the contents of the prior information S1.

The prospective abnormal shadow detecting means 1 carries out on the overall image signal S read out from the memory means 20 the aforesaid iris filter processing and morphology operation processing and calculates output values I of the iris filter processing and output values P(i, j) and M_{grad} of the morphology operation for given parts. Then the prospective abnormal shadow detecting means 1 compares the output value I of the iris filter processing for each part with the threshold value T1 changed by the detecting level changing means 3 and compares the output values P(i, j) and M_{grad} of the morphology operation for each part with the threshold values T2 and T3 changed by the detecting level changing means 3. When the output value I of the iris filter processing for the part is larger than the threshold value T1 (I>T1), the prospective abnormal shadow detecting means 1 determines that the part is a prospective growth shadow Pp, and otherwise (i.e., when the output value I of the iris filter processing for the part is not larger than the threshold value T1 (I≦T1), the prospective abnormal shadow detecting means 1 determines that the part is not a prospective growth shadow Pp. Further, when P(i, j) and M_{grad} for the part are not respectively smaller than the threshold values T2 and T3, that is, when P(i, j)≧T2 and M_{grad}≧T3, the prospective abnormal shadow detecting means 1 determines that the part is a prospective micro calcification shadow Pq. Otherwise, the prospective abnormal shadow detecting means 1 determines that the part is not a prospective micro calcification shadow Pq.

The local image signals Sp and Sq detecting the prospective abnormal shadows detected by the prospective abnormal shadow detecting means 1 are input into the local image processing means 40. The local image processing means 40 carries out on the local image signals Sp and Sq image processing for enhancing the prospective abnormal shadows Pp and Pq represented by the local image signals Sp and Sq, and outputs processed local image signals Sp′ and Sq′.

The processed overall image signal S′ processed by the overall image processing means 30 and the local image signals Sp and Sq processed by the local image processing means 40 are input into the display means 50. The display means 50 displays the overall image P represented by the processed overall image signal S′ with the parts corresponding to the prospective abnormal shadows Pp and Pq replaced by the prospective abnormal shadows Pp′ and Pq′ represented by the processed local image signal Sp′ and Sq′.

As a result, the overall image P′ together with the prospective abnormal shadows Pp′ and Pq′ enhanced more than the overall image P′ is displayed and read by a reader, e.g., a doctor. Since the prospective abnormal shadows Pp′ and Pq′ are obtained by changing the detecting level according to the prior information on the object, the reader need not take into account the prior information when reading the radiation image.

Though in the embodiment described above, the detecting level is changed by changing the threshold values T1, T2 and T3, the detecting level may be changed in other various ways. For example, the detecting level may be changed by the size and/or the shape of structural elements employed in the morphology operation processing.

Though in the embodiment described above, the detecting level is changed over the entire area of the mammogram P, the detecting level changing means 3 may be arranged to change the detecting level part by part of the mammogram P. For example, when the part where there is induration can be specified to some extent through, for instance, prior information obtained by examination by touch, the detecting level may be changed only for a specified part of the image. With this arrangement, detection of a prospective abnormal shadow can be effected attaching greater importance to the specified part.

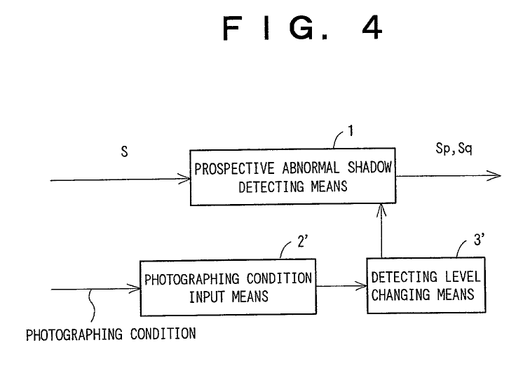

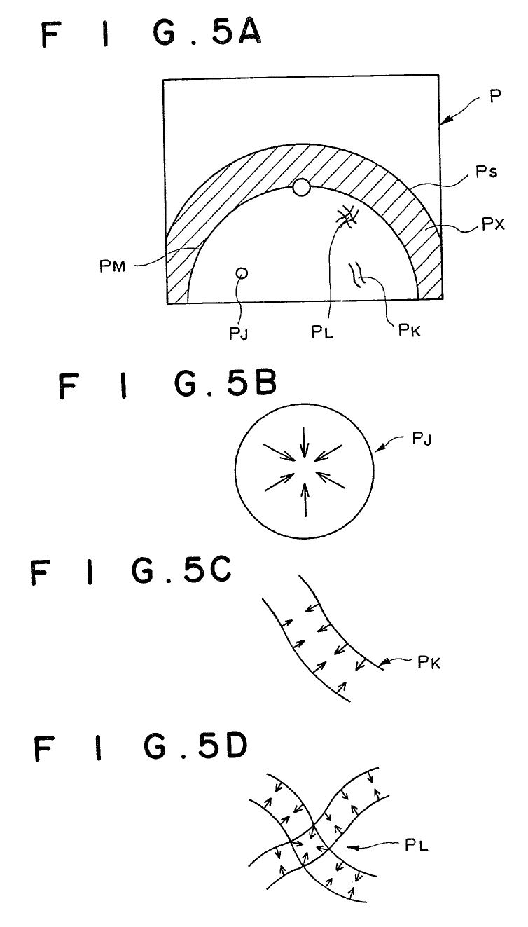

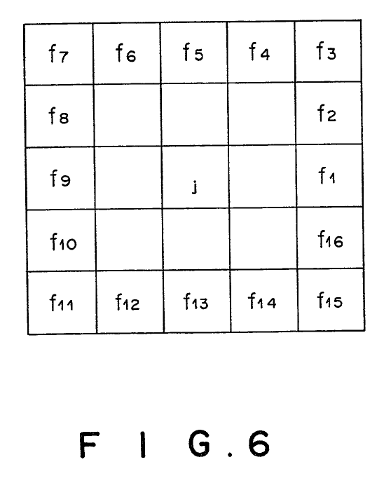

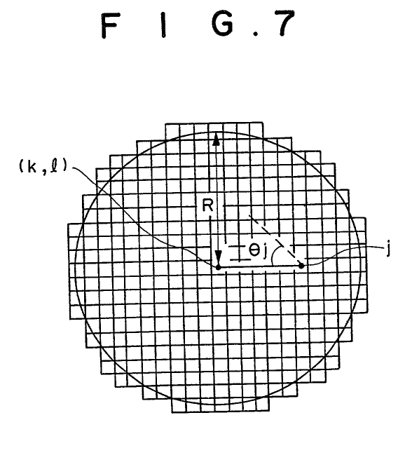

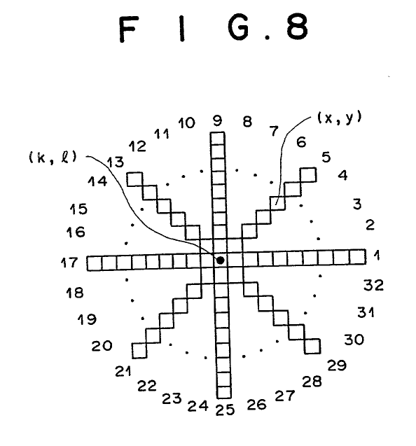

FIG. 4 shows a prospective abnormal shadow detecting system 10′ in accordance with a second embodiment of the present invention. The prospective abnormal shadow detecting system 10′ of this embodiment differs from that of the first embodiment in that a photographing condition input means 2′ through which the photographing conditions under which the mammogram P is taken, e.g., the tube voltage and/or current of the radiation source, the irradiating time, the mAs value, the degree of compression of the object breast, whether a grid is used, the kind of the grid used, the magnifying power and the like, are input is provided in place of the prior information input means 2 and a detecting level changing means 3′ which changes the detecting level according to the photographing conditions input through the photographing condition input means 2′ is provided in place of the detecting level changing means 3 which changes the detecting level according to the prior information.

With the prospective abnormal shadow detecting system 10′ of this embodiment, the prospective abnormal shadow can be surely detected even in a mammogram P which is obtained, for instance, with a small irradiation dose and accordingly in which a structure which is high in spatial frequency (e.g., a micro calcification shadow) is less apt to be detected since the detecting level is changed so that the detection probability of a prospective abnormal shadow is increased according to the photographing conditions. Further the reader need not take into account the photographing conditions when reading the mammogram P.

The prospective abnormal shadow detecting system 10′ of this embodiment may be employed in the computer-aided radiation image diagnosis apparatus 60 shown in FIG. 2 in place of the prospective abnormal shadow detecting system 10 of the first embodiment.

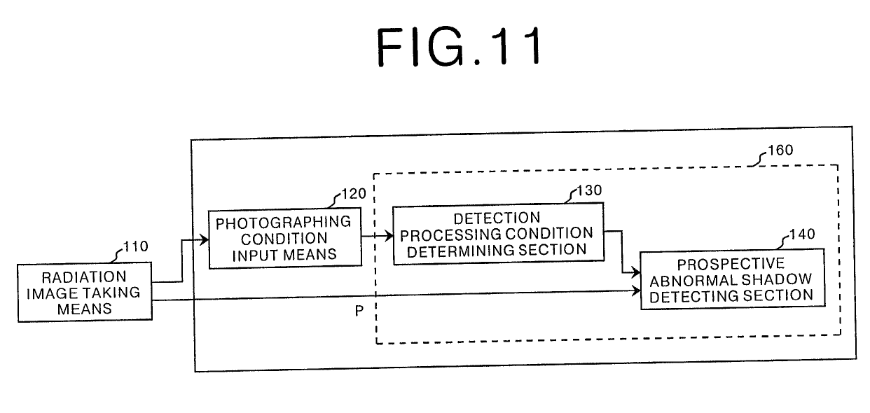

A prospective abnormal shadow detecting apparatus in accordance with a third embodiment of the present invention will be described with reference to FIG. 11, hereinbelow.

As shown in FIG. 11, the prospective abnormal shadow detecting apparatus comprises a photographing condition input means 120 into which a radiation image taking means 110 for taking a radiation image of an object (breast) inputs photographing conditions, a detection processing condition determining section 130 which determines the detection processing conditions on the basis of the photographing conditions input into the photographing condition input means 120, and a prospective abnormal shadow detecting section 140 which receives the detection processing conditions and original image data P representing the radiation image of the object respectively from the detection processing condition determining section 130 and the radiation image taking means 110 and detects a prospective abnormal shadow in the radiation image on the basis of the radiation image data P and the detection processing conditions determined by the detection processing condition determining section 130. The detection processing condition determining section 130 and the prospective abnormal shadow detecting section 140 form a prospective abnormal shadow detecting means 160.

The photographing conditions such as on the kind of the grid employed in photographing, the tube voltage, the filter, the irradiation dose, the pressure on the object, the thickness of the object under pressure, and the like are input into the photographing condition input means 120 manually by the operator or automatically from the radiation image taking means 110.

In this particular embodiment, a micro calcification shadow is detected as the abnormal shadow.

Operation of the prospective abnormal shadow detecting apparatus of this embodiment will be described hereinbelow.

The photographing condition input means 120 inputs the pressure on the object into the detection processing condition detecting section 130.

The detection processing condition detecting section 130 determines the detection processing conditions on the basis of the pressure on the object input.

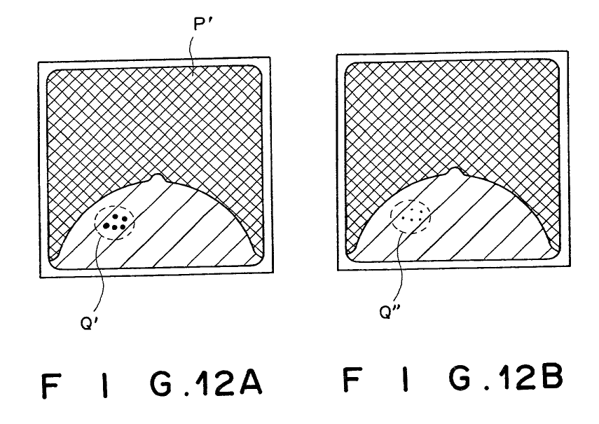

The pressure on the object is a pressure under which the breast is pressed during radiography of the breast. It is said that the pressure on the breast should be not smaller than 100N in order to obtain optimal radiation image data where a micro calcification shadow (Q′) is clearly shown as shown in FIG. 12A. However, such an optimal pressure sometimes cannot be obtained, and it is believed that, when the pressure is weak, an image in which the micro calcification shadow is thin (Q″) as shown in FIG. 12B (an image weak in contrast) is obtained. Accordingly, when the pressure is not higher than 100N, a calcification enhancement filter is employed according to the pressure.

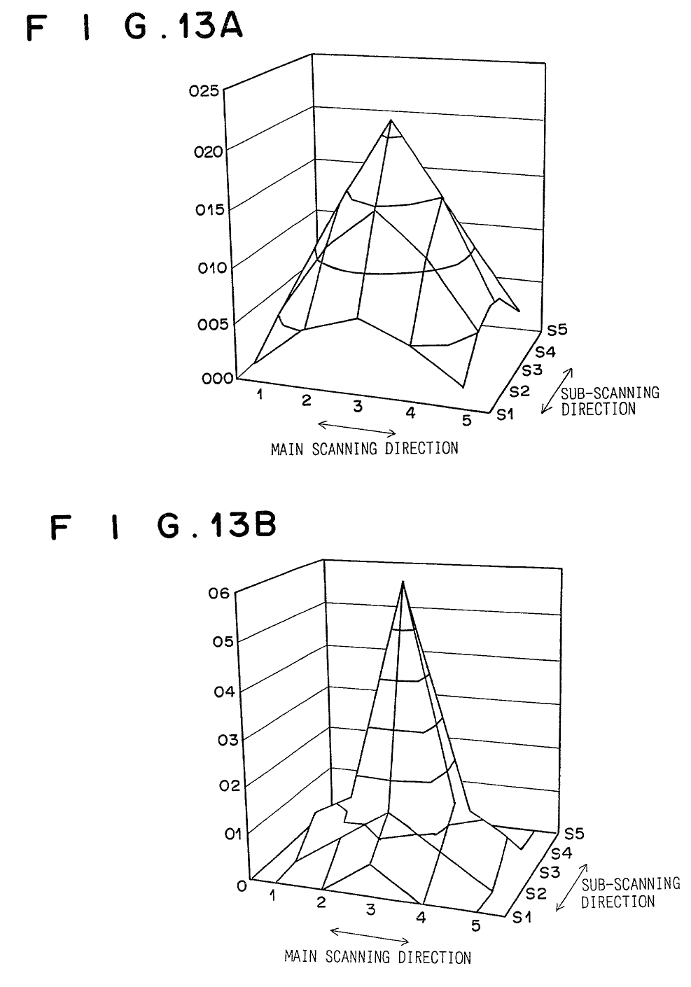

That is, the detection processing condition determining section 130 determines to use a first calcification enhancement filter such as shown in FIG. 13A which is equivalent in properties to a thin micro calcification shadow when the pressure is not higher than 50N, determines to use a second calcification enhancement filter such as shown in FIG. 13B which is equivalent in properties to a typical micro calcification shadow when the pressure is higher than 50N and not higher than 100N, and determines to use no calcification enhancement filter when the pressure is higher than 100N.

The calcification enhancement filter is a matched filter representing the size and density distribution of the micro calcification shadow as they are and a plurality of calcification enhancement filters having different properties optimized according to the properties of radiation images which fluctuate according to the photographing conditions are prepared so that one of the filters is used according to the properties of the radiation image to be processed.

The filters shown in FIGS. 13A and 13B are represented by the relation between the pixel positions in the main scanning direction and the sub-scanning direction and the density ratio (maximum density/density of the micro calcification shadow). The first calcification filter shown in FIG. 13A corresponds to properties of an unsharp micro calcification shadow and is relatively small (about 0.2) in the density ratio at the center of the calcification shadow and has a relatively large base (about 5 pixels×5 pixels). To the contrast, the second calcification filter shown in FIG. 13B corresponds to properties of a typical micro calcification shadow and is relatively large (about 0.55) in the density ratio at the center of the calcification shadow and has a relatively small base (about 2 pixels×2 pixels).

The calcification enhancement filter processing is carried out on a subtraction image obtained on the basis of the difference between the original image and a smoothened image obtained by carrying out smoothening processing by the morphology operation (the opening processing or the closing processing) on the original image.

The prospective abnormal shadow detecting section 140 detects a prospective abnormal shadow in the radiation image, represented by the original image data P input from the radiation image taking means 110, according to the detection processing conditions determined by the detection processing condition determining section 130. Detection of a prospective micro calcification shadow by morphology operation using preset threshold values with a calcification enhancement filter (a shape-dependent filter) used as the detection processing condition will be described here.

The prospective abnormal shadow detecting section 140 first obtains a micro structure image by carrying out the morphology operation processing on the original image data P. (The fundamentals of morphology operation)

Though the morphology operation is generally developed as a set theory in a N-dimensional space, it will be discussed here on the basis of a two-dimensional tone image for the purpose of simplicity of understanding.

It is assumed that a tone image is a space in which a point (x, y) has a height corresponding to a value of density f(x, y). Further it is assumed that the value of density f(x, y) is represented by a high brightness, high level signal in which as the value of density decreases (the value of brightness increases when displayed on a CRT), the level of the signal becomes higher.

For the purpose of simplicity, a linear function f(x) corresponding to a cross-section of the image is first discussed. It is assumed that a structural element g employed in the morphology operation is a function which is represented by the following formula (18), is symmetrical about the origin, and is 0 in value in a domain represented by the following formula (19).

g^{s}(x)=g(−x) (18)

G={−m, −m+1, . . . , −1, 0, 1, . . . , m−1, m} (19)

At this time, the fundamental form of the morphology operation is very simple as shown in the following formulae (20) to (23).

dilation: [f G^{s}](i)=max {f(i−m), . . . , f(i), . . . , f(i+m)} (20)

erosion: [f G²](i) =min {f(i−m), . . . , f(i), . . . , f(i+m)} (21)

opening: fₛ=(f g^{s})g (22)

closing: f^{s}=(f g^{s})g (23)

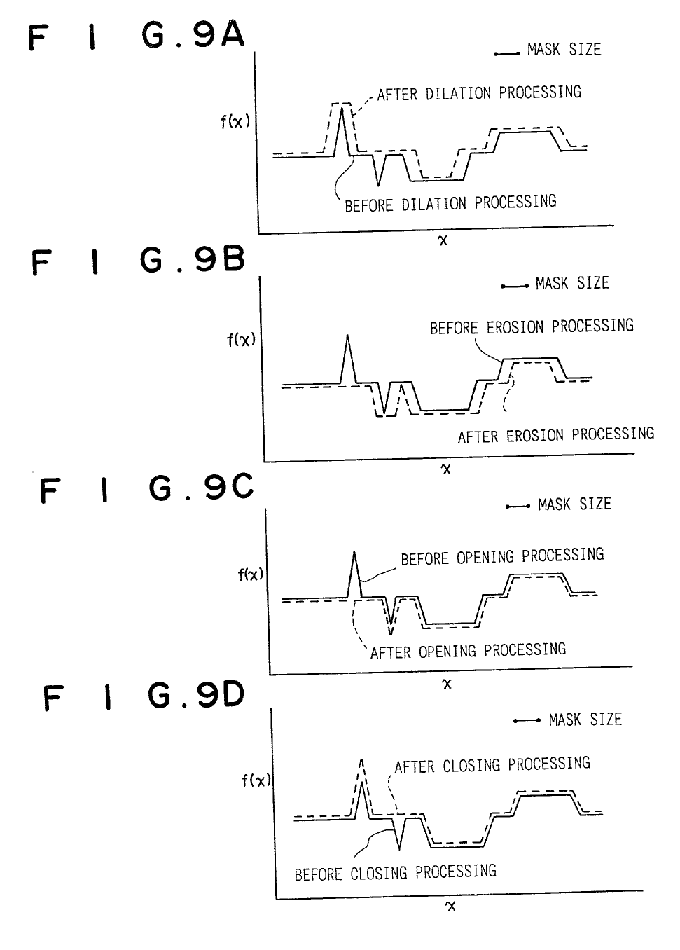

That is, the dilation processing is processing for searching a maximum value in the area whose width is ±m (a value determined according to the structural element B) and whose center is at the pixel of current interest, see FIG. 9A, and the erosion processing is processing for searching a minimum value in the same area, see FIG. 9B. The opening processing corresponds to searching a maximum value after searching a minimum value, and the closing processing corresponds to searching a minimum value after searching a maximum value. In other words, the opening processing smoothens the density curve f(x) from the low brightness side by removing protrusions in density (the portions which are higher in brightness than the surroundings) which are narrower than the mask size 2 m (see FIG. 9C), whereas the closing processing smoothens the density curve f(x) from the high brightness side by removing recesses in density (the portions which are lower in brightness than the surroundings) which are narrower than the mask size 2 m (see FIG. 9D).

In the case of a high density, high level signal in which as the value of density increases, the level of the signal becomes higher, the value of image signal for the value of density f(x) is reverse to that of a high brightness, high level signal. Accordingly, the dilation processing for a high density, high level signal corresponds to the erosion processing for a high brightness, high level signal. Similarly, the erosion processing for a high density, high level signal corresponds to the dilation processing for a high brightness, high level signal, the opening processing for a high density, high level signal corresponds to the closing processing for a high brightness, high level signal, and the closing processing for a high density, high level signal corresponds to the opening processing for a high brightness, high level signal. Description will be made only on the high brightness, high level signal here.

(Application to Detection of a Calcification Shadow)

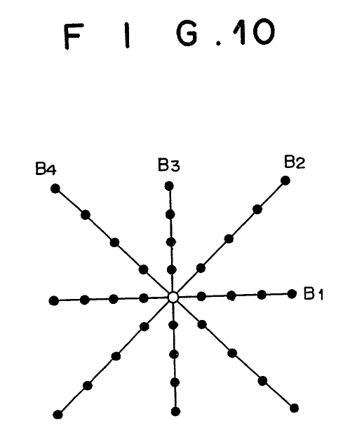

As a method of detecting a calcification shadow, a subtraction method in which a smoothened image is subtracted from an original image is conceivable. Since it is difficult to distinguish a calcification shadow from an elongated non-calcification shadow (e.g., of a mammary gland, a blood vessel, and a mammary gland supporting tissue) by a simple smoothening method, Obata, et al, have proposed morphology operation processing based on opening operation using multiple structural elements as represented by the following formula (24). See “Extraction of Micro Calcification Shadow by a Morphology Filter using multiple Structural Elements” (Journal of Academy of Electronics/Information/Communication D-II, vol. J75-D-II No. 7, pp1170 to 1176, July 1992) and “Fundamentals of Morphology and its Application to Mammogram” MEDICAL IMAGING TECHNOLOGY, Vol. 12, No. 1 January 1994)

$$\begin{matrix}P = f - {max}_{i ∈ ( 1 , … , M )} \{ ( f ⊖ Bi ) ⊕ Bi \} \\ = f - {max}_{i ∈ ( 1 , … , M )} \{ {f}_{Bi} \}\end{matrix} \qquad ( 24 )$$

wherein Bi (i stands for 1, 2, 3 and 4) are four linear structural elements B shown in FIG. 10. When the structural elements B are larger than the calcification shadow to be detected, calcification shadows which are signal protrusions narrower than the structural elements B (a part of image the image signal of which fluctuates in a range spatially narrower than the structural elements B) are removed by opening processing. On the other hand, an elongated non-calcification shadow is left there as it is after the opening processing (calculation of the second term in formula 14) so long as it is longer than the structural elements B and its inclination (the direction in which the shadow extends) conforms to any one of the four structural elements Bᵢ. Accordingly, by subtracting the smoothened image (the image removed with the calcification shadow) obtained by the opening processing from the original image f, an image containing therein only a small prospective calcification shadow is obtained. This the concept of formula (24).

In the case of a high density, high level signal, closing processing is applied according to the following formula (15) in place of opening processing.

$$\begin{matrix}P = f - {min}_{i ∈ ( 1 , … , M )} \{ ( f ⊕ Bi ) ⊖ Bi \} \\ = f - {min}_{i ∈ ( 1 , … , M )} \{ {f}_{Bi} \}\end{matrix} \qquad ( 25 )$$

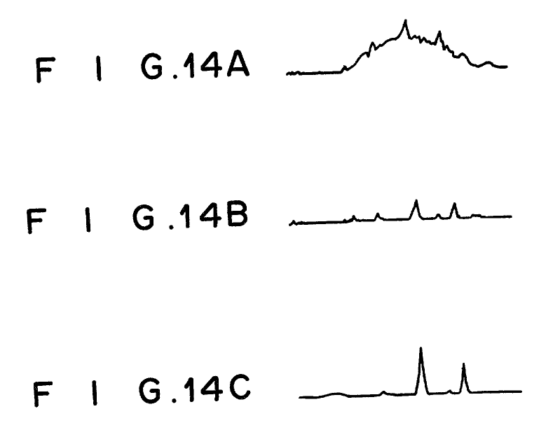

The image obtained according to formula (24) or (25), that is, the subtraction image obtained on the basis of the difference between the original image and a smoothened image obtained by removing a calcification shadow from the original image, is the micro structure image. See FIG. 14B. FIG. 14A shows the original image.

Then the prospective abnormal shadow detecting section 140 processes the micro structural image with the calcification enhancement filter determined by the detection processing condition determining section 130, thereby specifically enhancing a micro calcification shadow on the micro structural image having properties equivalent to the calcification enhancement filter. See FIG. 14C. When the detection processing condition determining section 130 determines that no calcification enhancement filter is used, the calcification enhancement processing is not carried out.

Then the prospective abnormal shadow detecting section 140 carries out on the resultant image the same threshold processing as the conventional processing and detects a prospective calcification shadow.

That is, non-calcification shadows contained in P of formula (24) are further removed by the use of differential information based on a morphology operation according to the following formula (26).

M_{grad}=(−1/2)×{f λB·f λB} (26)

As the value of M_{grad} increases, the probability that the shadow is of a calcification increases. Accordingly, a prospective calcification shadow Cₛ can be obtained according to the following formula (27).

If P(i, j)≧T2, and M_{grad}(i, j)≧T3

Then, Cₛ(i, j)=P else Cₛ(i, j)=0 (27)

T2 and T3 are empirically determined threshold values.

Since a non-calcification shadow different from a calcification shadow in size can be removed only by comparison of P obtained according to formula (24) and the threshold value T2, only the condition of the first term of formula (27), P(i, j)≧T2 has to be satisfied in the case where there is no possibility that a non-calcification shadow equivalent to a calcification shadow in size remains.

Finally, the cluster Cc of the calcification shadow is detected by a combination of a multi-scale opening operation and closing operation represented by the following formula (28).

C_{c}=Cₛ λ₁B λ₃B λ₂B (28)

λ₁ and λ₂ are respectively determined by the maximum distance between calcification shadows to be fused and the maximum radius of an isolated shadow to be removed, and λ₃=λ₁+λ₂.

Though, in the third embodiment described above, a calcification enhancement filter is used as the detection processing condition, the threshold values T₂ and T₃ may be changed according to the photographing conditions input in place of using such a calcification enhancement filter.

Further, though in the third embodiment described above, the pressure on the object is employed as the photographing condition, other various photographing conditions may be employed as the photographing condition and the detection processing condition may be determined to conform to the photographing condition.

For example, when “the thickness to which the breast is compressed” is large, the calcification shadow can become unsharp and accordingly, it is preferred that different calcification enhancement filters be used depending on the thickness to which the breast is compressed.

When the irradiation dose is small, more noise is contained in the image data and it is difficult to separate the noise from the calcification shadow. In this case, the calcification enhancement processing with a calcification enhancement filter is not carried out and the threshold values T2 and T3 are increased not to detect excessive noise.

The filter is a plate of aluminum, molybdenum or the like for controlling the quality of radiation. When a filter of a material other than molybdenum is used, the radiation image can deteriorates in contrast and accordingly, it is preferred that the calcification enhancement processing be carried out by the use of the first calcification enhancement filter corresponding to an unsharp micro calcification shadow.

When the tube voltage is higher than 30 kV, the radiation image can deteriorates in contrast and accordingly, it is preferred that the calcification enhancement processing be carried out by the use of the first calcification enhancement filter corresponding to an unsharp micro calcification shadow.

The “kind of the grid” means the kind of the grid mounted on the X-ray apparatus. When an HTC grid formed of tantalum and air is employed, the image is apt to be extraordinarily high in contrast as compared with when a typical grid formed of lead and aluminum is employed. Accordingly, when an HTC grid is employed, the values of the threshold values employed in the calcification detection processing are increased by adding, for instance, 0.50 to the standard threshold values. Since the value, 0.50, was empirically determined on the basis of 10 bit images, the value to be added to the standard threshold values need not be limited to 0.50.

Generally, the abnormal shadow detecting level can largely differ between when a grid formed with air employed as a part of the material is employed and when a grid formed without air employed as apart of the material (a material other than air absorbing the radiation is employed in place of air) is employed. Accordingly, when a grid formed with air employed as a part of the material is employed, it is preferred that the detection processing conditions be changed. The detection processing conditions may be changed according to other various photographing conditions which can affect the result of detection. Further, the detection processing conditions, e.g., the properties of the calcification enhancement filter, the threshold values T2 and T3, and the like, may be changed in various ways according to the photographing conditions employed.

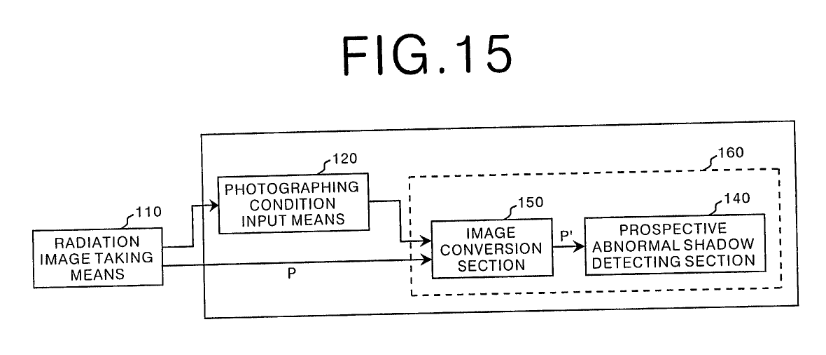

A prospective abnormal shadow detecting apparatus in accordance with a fourth embodiment of the present invention will be described with reference to FIG. 15, hereinbelow. In FIG. 15, the elements analogous to those shown in FIG. 11 are given the same reference numerals and will not be described in detail here.

As shown in FIG. 15, the prospective abnormal shadow detecting apparatus of this embodiment comprises a photographing condition input means 120 into which a radiation image taking means 110 for taking a radiation image of an object (breast) inputs photographing conditions, an image conversion section 150 which carries out predetermined image conversion processing on the radiation image data P input from the radiation image taking means 110 on the basis of the photographing conditions input into the photographing condition input means 120, thereby obtaining converted radiation image data P′, and a prospective abnormal shadow detecting section 140 which receives the converted radiation image data P′ from the image conversion section 150 and detects a prospective abnormal shadow in the radiation image on the basis of the converted radiation image data P′. The image conversion section 150 and the prospective abnormal shadow detecting section 140 form a prospective abnormal shadow detecting means 160.

Operation of the prospective abnormal shadow detecting apparatus of this embodiment will be described hereinbelow.

The image conversion section 150 carries out on the original radiation image data P image conversion processing selected according to the photographing conditions input into the photographing condition input means 120, thereby obtaining a converted radiation image data P′. For example, the pressure on the object is lower than a predetermined value, the image conversion section 150 carries out high frequency enhancement processing on the original radiation image data P, thereby obtaining high-frequency enhanced radiation image data P′.

Then the prospective abnormal shadow detecting section 140 carries out on the high-frequency enhanced radiation image data P′ the same processing as the conventional processing and detects a prospective calcification shadow. That is, the prospective abnormal shadow detecting section 140 carries out on the high-frequency enhanced radiation image data P′ smoothening processing by morphology operation as in the third embodiment, thereby obtaining a micro structure image. Then the prospective abnormal shadow detecting section 140 further removes the non-calcification image from the micro structure image and detects a prospective calcification shadow by the use of the threshold values T2 and T3.

Though, in the embodiments described above, a micro calcification shadow is detected by morphology operation, other abnormal shadows may be detected in accordance with the present invention.

Further, the present invention may be applied not only to a mammogram but also to other various radiation images such as a chest radiograph.

What is claimed is:

1. A method of detecting a prospective abnormal shadow in an image at a predetermined detecting level, wherein the improvement comprises
the step of changing the detecting level according to prior information on the object.

2. A method as defined in claim 1 in which the prior information is at least one of information obtained from meeting with the patient, information obtained from examination by touch and the past history of the patient.

3. A method as defined in claim 1 in which the detecting level is changed part by part of the image.

4. A method as defined in claim 1 in which the image of the object is a mammogram.

5. A method of detecting a prospective abnormal shadow in an image of an object at a predetermined detecting level, wherein the improvement comprises
the step of changing the detecting level according to photographing conditions under which the image of the object is taken.

6. A method as defined in claim 5 in which the photographing conditions is at least one of the tube voltage or the tube current of the radiation source, the irradiating time, the product of the tube current and the irradiating time, the degree of compression of the object when the object is photographed under pressure, whether a grid is used, the kind of the grid used, and the magnifying power.

7. A method as defined in claim 5 in which the detecting level is changed part by part of the image.

8. A method as defined in claim 5 in which the image of the object is a mammogram.

9. A system for detecting a prospective abnormal shadow in an image of an object comprising a prospective abnormal shadow detecting means which detects a prospective abnormal shadow at a predetermined detecting level, wherein the improvement comprises that
there are provided a prior information input means through which prior information on the object is input, and a detecting level changing means which changes the detecting level according to the prior information on the object input through the prior information input means, and
that the prospective abnormal shadow detecting means detects a prospective abnormal shadow according to the detecting level changed by the detecting level changing means.

10. A system as defined in claim 9 in which the prior information is at least one of information obtained from meeting with the patient, information obtained from examination by touch and the past history of the patient.

11. A system as defined in claim 9 in which the detecting level changing means changes the detecting level part by part and the prospective abnormal shadow detecting means detects a prospective abnormal shadow according to the detecting level changed by the detecting level changing means part by part.

12. A system as defined in claim 9 in which the image of the object is a mammogram.

13. A system for carrying out the method of detecting a prospective abnormal shadow in a radiation image in accordance with the second aspect of the present invention. That is, in accordance with the fourth aspect of the present invention, there is provided a system for detecting a prospective abnormal shadow in an image of an object comprising a prospective abnormal shadow detecting means which detects a prospective abnormal shadow at a predetermined detecting level, wherein the improvement comprises that
there are provided a photographing condition input means through which photographing conditions under which the image of the object is taken is input, and a detecting level changing means which changes the detecting level according to the photographing conditions input through the photographing condition input means, and
that the prospective abnormal shadow detecting means detects a prospective abnormal shadow according to the detecting level changed by the detecting level changing means.

14. A system as defined in claim 13 in which the photographing conditions is at least one of the tube voltage or the tube current of the radiation source, the irradiating time, the product of the tube current and the irradiating time, the degree of compression of the object when the object is photographed under pressure, whether a grid is used, the kind of the grid used, and the magnifying power.

15. A system as defined in claim 13 in which the detecting level changing means changes the detecting level part by part and the prospective abnormal shadow detecting means detects a prospective abnormal shadow according to the detecting level changed by the detecting level changing means part by part.

16. A system as defined in claim 13 in which the image of the object is a mammogram.

17. An apparatus for detecting a prospective abnormal shadow in a radiation image of an object comprising
a photographing condition input means through which photographing conditions under which the radiation image of the object is taken is input, and
a prospective abnormal shadow detecting means which detects a prospective abnormal shadow on the basis of the photographing conditions input through the photographing condition input means and radiation image data representing the radiation image of the object.

18. An apparatus as defined in claim 17 in which the prospective abnormal shadow detecting means comprises a detection processing condition determining section which determines the detection processing conditions on the basis of the photographing conditions, and a prospective abnormal shadow detecting section which detects a prospective abnormal shadow through a predetermined detection processing on the basis of the radiation image data and the detection processing conditions determined by the detection processing condition determining section.

19. An apparatus as defined in claim 18 in which the detection processing condition is a threshold value employed in the detection processing.

20. An apparatus as defined in claim 18 in which the detection processing condition is filtering properties of a shape-dependent filter employed in the detection processing.

21. An apparatus as defined in claim 17 in which the prospective abnormal shadow detecting means comprises an image conversion section which carries out predetermined image conversion processing on the radiation image data on the basis of the photographing conditions, and a prospective abnormal shadow detecting section which detects a prospective abnormal shadow through a predetermined detection processing on the basis of the converted radiation image data.

22. An apparatus as defined in claim 21 in which the image conversion processing is frequency enhancement processing.

23. An apparatus as defined in claim 17 in which the photographing conditions is at least one of the kind of the grid employed in photographing, the tube voltage, the filter, the irradiation dose, the pressure on the object and the thickness to which the object is compressed.

24. An apparatus as defined in claim 17 in which the radiation image is a mammogram.

25. An apparatus as defined in claim 17 in which the prospective abnormal shadow is a prospective micro calcification shadow.
